(19) United States
(12) Patent Application Publication
(10) Pub. No.: US 2008/0097861 A1
(43) Pub. Date: Apr. 24, 2008

(54) System and method providing backup local ordering for establishment using a remote ordering system

(75) Inventors: Steven T. Awiszus, St. Paul, MN (US); Robert H. Siuda, St. Paul, MN (US)

Correspondence Address: IPLM GROUP, P.A., POST OFFICE BOX 18455, MINNEAPOLIS, MN, 55418, US

(73) Assignee: 3M Innovative Properties Company

(21) Appl. No.: 12/001,301

(22) Filed: Dec. 11, 2007

Related U.S. Application Data
(63) Continuation of application No. 10/910,033, filed on Aug. 3, 2004, now abandoned.

(51) Int. Cl. G06Q 50/00; G06Q 30/00

(52) U.S. Cl. 705/15; 705/26

(57) ABSTRACT

An order taking system and method for an establishment, or a plurality of establishments, each having an order taking facility associated with the establishment enabling a customer to place an order for an item from the establishment. Order placing equipment is located near the order taking facility being capable of receiving an order for the item from the customer. A remote order taking facility is located remotely from the establishment. A local order taking facility is associated with the establishment. A first communication link is used between the order placing equipment of the order taking facility and the remote order taking facility. A second communication link is used between the order placing equipment and the local order taking facility. The order taking system is operable in a first mode operatively coupled via said first communication link to said remote order taking facility and in a second mode operatively coupled via said second communication link to said local order taking facility.

This application is a continuation of U.S. patent application Ser. No. 10/910,033, filed Aug. 3, 2004, and claims priority therefrom.

### TECHNICAL FIELD

This invention relates to an ordering system for ordering items from an establishment and method therefore and, more particularly, to such an ordering system utilizing a remote order taking facility.

### BACKGROUND

It is common for retail establishments, particularly restaurants, to facilitate drive-up customers with drive-up lanes and windows to service the customer. A customer will typically drive up to a menu/order board and communicate the customer's wishes from the vehicle to staff, including an order taker, inside the retail establishment. The customer, still in the vehicle, will then proceed to one or more windows in order to pay for the purchase, if required, and pick up the merchandise.

An intercom system typically facilitates communication between the occupant of the vehicle, the customer, and the staff inside the establishment. In a “fast food” restaurant situation, a post mounted speaker and microphone, located near a menu board, is hard wired to an intercom base station located inside the restaurant. The base station wirelessly communicates with a portable device worn by an order taker. The portable device is typically a transceiver worn as a belt pack and an accompanied wired headset. Alternatively, in some instances, the portable device is self-contained on a wearable headset eliminating the need for a belt pack. The order taker typically listens continually to the post mounted microphone and presses a button in order to speak to the vehicle occupant as needed.

In many systems and methods of ordering items from an establishment from a drive-up or drive-thru facility, the order is orally communicated directly from the post-mounted speaker and microphone to an order taking facility, typically a drive-thru order specialist wearing a headset, in the establishment. The order specialist, or others, then collect the ordered item or items and handle the transaction with the customer at a drive-up window, taking money for the ordered item, making change and handing the order to the customer. This system and method usually results in a satisfactory and convenient manner in which the customer obtains the ordered item without leaving the vehicle. However, staff in the establishment, including the order specialist, can become overwhelmed during peak activity periods especially since the order specialist may also have other responsibilities associated with the establishment.

Recently, systems and methods have been developed in which the order taking process is moved off-site from the establishment. An example is described in U.S. Patent Application Publication No. US2003/0225622, Doan, entitled “Method and System For Entering Orders of Customers.” In Doan, a communication link is established between an offsite employee and an order-placing talk box at a restaurant. The communication link is utilized for two-way voice communication so that a food order can be taken from a customer located at the restaurant by the offsite employee. A data communication link is utilized by the offsite employee to enter the order into the onsite computer-based sales management system which facilitates food preparation, fee collection, and the recording of sales. The offsite employee can utilize a personal computer to accomplish the stated functions, the communication link can be provided by the internet and the customer can be located within a vehicle adjacent the restaurant when placing the order.

### SUMMARY OF THE INVENTION

While the afore-mentioned offsite system and method described in Doan allows shifting of duties and resources from the local establishment, the system and method also brings forth a host of additional issues and problems, usually of a type not occurring in previous, all-local ordering systems.

Since the offsite system is dependent upon a communication link between the order placing facility at the establishment to the physical location at which the order taking facility is located, it is recognized that foreseen and unforeseen problems may be encountered with the communication link which may render the offsite ordering process not completely reliable. If and when this should occur, the establishment may be unable to fulfill orders from customers possibly located only feet from the establishment. One embodiment of the present invention involves establishing a backup communications link between the order placing facility and the establishment in event that the offsite ordering facility can not take orders for the establishment and/or can not communicate those orders taken to the establishment. Other aspects of the present invention involve important and unforeseen systems and procedures for switching from and to an offsite order taking facility and systems and processes for ancillary communication important for the smooth and preferably seamless switching between ordering systems.

In a preferred embodiment, the present invention provides an order taking system for an establishment having an order placing facility associated with the establishment enabling a customer to place an order for an item from the establishment. Order placing equipment is located near the order placing facility being capable of receiving an order for the item from the customer. A remote order taking facility is located remotely from the establishment. A local order taking facility is associated with the establishment. A first communication link is used between the order placing equipment of the order placing facility and the remote order taking facility. A second communication link is used between the order placing equipment and the local order taking facility. The order taking system is operable in a first mode operatively coupled via said first communication link to said remote order taking facility and in a second mode operatively coupled via said second communication link to said local order taking facility.

In a preferred embodiment, the order taking system switches from the first mode to the second mode under control of the establishment.

In a preferred embodiment, the order taking system switches from the first mode to the second mode automatically.

In a preferred embodiment, the order taking system switches from the first mode to the second mode in response to the first communication link becoming unavailable.

In a preferred embodiment, the order taking system switches from the first mode to the second mode in response to the first communication link becoming unavailable for a predetermined period of time.

In a preferred embodiment, the order taking system switches from the second mode back to the first mode in response to the first communication link becoming available.

In a preferred embodiment, the order taking system switches from the second mode to the first mode only after a predetermined period of time elapses between successive ones of the customer at the order placing facility.

In a preferred embodiment, the order taking system switches from the first mode to the second mode dependent upon a time of day.

In a preferred embodiment, a third communication link is utilized between the remote order taking facility and the establishment, the third communication link being capable of communicating the order from the remote order taking facility to the establishment.

In a preferred embodiment, a fourth communication link from the order placing facility to the establishment allowing a person in the establishment to monitor communication occurring on the first communication link.

In a preferred embodiment, the third communication link allows the remote order taking facility to contact the establishment in order to follow up on the order.

In a preferred embodiment, the order placing equipment is a microphone located near the order placing facility, the microphone being capable of receiving an oral order for the item from the customer; and a speaker located near the order placing facility, the speaker being capable of being heard by the customer located at the order placing facility.

In a preferred embodiment, the first communication link facilitates oral communication of the order from the order placing facility to the remote order taking facility and facilitates oral communication from the remote order taking facility to the order placing facility and the second communication link facilitates oral communication of the order from the order placing facility to the local order taking facility and facilitates oral communication from the local order taking facility and the order placing facility.

In another embodiment, the present invention provides an order taking system for a plurality of establishments, each one of the plurality of establishments having an order placing facility associated with the one of the plurality of establishments enabling a customer to place an order for an item from the one of the plurality of establishments. A plurality of order placing equipments are each located near the order placing facility associated with one the establishments and capable of receiving an order for the item from the customer. A remote order taking facility is located remotely from the establishment. A plurality of local order taking facilities are each associated with the one of the plurality of establishments. A first communication link is associated with each of the plurality of establishments between the order placing equipment to the remote order taking facility. A second communication link is associated with each of the plurality of establishments between the order placing equipment of the order placing facility to the local order taking facility. A control is associated with each of the plurality of establishments, operatively coupled to the first communication link and to the second communication link and located locally with respect to the establishment allowing the establishment to switch between the first communication link to the second communication link.

In a preferred embodiment, each of the plurality of establishments, through the use of the control, may individually select either of the first communication link and the second communication link to be active at any point in time.

In another embodiment, the present invention provides a switching system for an establishment having an order placing facility associated with the establishment enabling a customer to place an order for an item from the establishment. A first communication link is established between the order placing facility and a remote order taking facility. A second communication link is established between the order placing facility and the local order taking facility. The switching system is capable of switching between the first communication link and the second communication link.

In another embodiment, the present invention provides a method of taking orders for an establishment having an order placing facility associated with the establishment enabling a customer to place an order for an item from the establishment using a remote order taking facility located remotely from the establishment, a local order taking facility located within the establishment, a first communication link between the order placing equipment and the remote order taking facility and a second communication link between the order placing equipment and the local order taking facility. The first communication link is used to communicate the order to the remote order taking facility. The third communication link is used to communicate the order to the establishment. Communication is switched from the first communication link to the communication link to communicate the order from another customer at the order placing facility to the establishment directly without utilizing the remote order taking facility.

In a preferred embodiment, the switching step occurs when order taking through the remote order taking facility fails to operate satisfactorily.

In a preferred embodiment, communication is further switched back from the second communication link to the first communication link.

In a preferred embodiment, the switching steps are under control of the establishment.

In a preferred embodiment, only one of the first communication link and the second communication link is active at any point in time.

In a preferred embodiment, the first communication link is active by default.

In a preferred embodiment, the establishment is a restaurant and the order is a food order.

In a preferred embodiment, the remote order taking facility comprises a call center.

In a preferred embodiment, the first communication link, at least in part, is the internet.

In a preferred embodiment, the second communication link is hard-wired.

In another embodiment, the present invention provides an order taking system for an establishment having an order placing facility associated with the establishment enabling a customer to place an order for an item from the establishment. Order placing equipment is located near the order placing facility being capable of receiving an order for the item from the customer. A first communication link is adapted to communicate between the order placing equipment and a remote order taking facility. The order taking system provides a first signal to the remote order taking facility in response to the customer being present at the order placing facility.

In another embodiment, the present invention provides a method of taking orders for an establishment having an order placing facility associated with the establishment enabling a customer to place an order for an item from the establishment, adapted to interface with a remote order taking facility located remotely from the establishment, having a local order taking facility located within the establishment, using a first communication link between the order placing equipment and the remote order taking facility. The first communication link is used to communicate the order to the remote order taking facility. The third communication link is used to communicate the order to the establishment. A first signal is provided to the remote order taking facility in response to the customer being present at the order placing facility.

In a preferred embodiment, the order taking system further provides a second signal to the establishment in response to the customer being present at the order placing facility.

In a preferred embodiment, a second communication link allows a person in the establishment to monitor communication occurring on the first communication link.

In a preferred embodiment, a third communication link is used between the remote order taking facility and the establishment, the third communication link being capable of communicating the order from the remote order taking facility to the establishment.

In a preferred embodiment, the third communication link allows the remote order taking facility to contact the establishment in order to follow up on the order.

In another embodiment, the present invention provides an order taking system for an establishment having an order placing facility associated with the establishment enabling a customer to place an order for an item from the establishment. Order placing equipment located near the order placing facility being capable of receiving an order for the item from the customer. A first communication link is adapted to communicate between the order placing equipment and a remote order taking facility. A second communication link allowing a person in the establishment to monitor communication occurring on the first communication link.

In another embodiment, the present invention provides a method of taking orders for an establishment having an order placing facility associated with the establishment enabling a customer to place an order for an item from the establishment, adapted to interface with a remote order taking facility located remotely from the establishment, having a local order taking facility located within the establishment, using a first communication link between the order placing equipment and the remote order taking facility. The first communication link is used to communicate the order to the remote order taking facility. The third communication link is used to communicate the order to the establishment. A person in the establishment is allowed to monitor communication occurring on the first communication link.

In a preferred embodiment, the order taking system further provides a signal to the establishment in response to the customer being present at the order placing facility.

In a preferred embodiment, a third communication link is provided between the remote order taking facility and the establishment, the third communication link being capable of communicating the order from the remote order taking facility to the establishment.

In a preferred embodiment, the third communication link allows the remote order taking facility to contact the establishment in order to follow up on the order.

In another embodiment, the present invention provides an order taking system for an establishment having an order placing facility associated with the establishment enabling a customer to place an order for an item from the establishment. Order placing equipment is located near the order placing facility being capable of receiving an order for the item from the customer. A first communication link is adapted to communicate between the order placing equipment and a remote order taking facility. A second communication link is provided between the remote order taking facility and the establishment, the second communication link being capable of communicating the order from the remote order taking facility to the establishment. The second communication link allows the remote order taking facility to contact the establishment in order to follow up on the order.

In another embodiment, the present invention provides a method of taking orders for an establishment having an order placing facility associated with the establishment enabling a customer at the order placing facility to place an order for an item from the establishment, adapted to interface with a remote order taking facility located remotely from the establishment, having a local order taking facility located within the establishment, using a first communication link between the order placing equipment and the remote order taking facility. The first communication link is used to communicate the order to the remote order taking facility. The third communication link is used to communicate the order to the establishment. The remote order taking facility is allowed to contact the establishment in order to follow up on the order.

In a preferred embodiment, the order taking system further provides a signal to the establishment in response to the customer being present at the order placing facility.

### BRIEF DESCRIPTION OF THE DRAWINGS

FIG. 1 illustrates a prior art intercom system utilizable in a drive up retail establishment;

FIG. 2 illustrates a prior art remote ordering system utilizing a call center;

FIG. 3 is a block diagram of an ordering system in accordance with an aspect of the invention; and

FIG. 4 is a detailed schematic diagram of a switching element utilized in accordance with an aspect of the invention.

### DETAILED DESCRIPTION

The entire contents of U.S. application Ser. No. 10/910,033, filed Aug. 3, 2004, is hereby incorporated by reference.

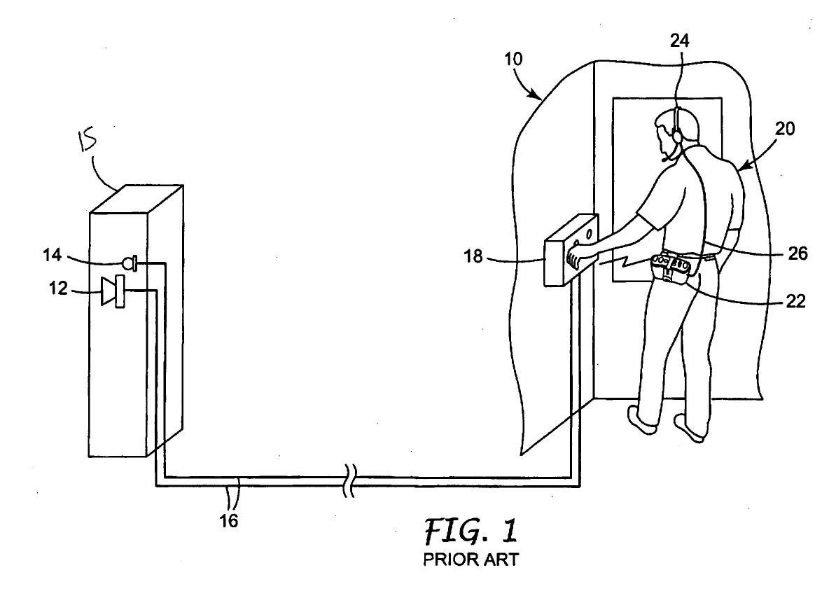

FIG. 1 illustrates a prior art intercom system useful in a retail establishment 10 having a drive up facility, such as a restaurant, and particularly useful in a fast food type restaurant having a drive up, or drive-thru, facility. Speaker 12 and microphone 14 are post 15 mounted near a menu board (not shown) adjacent the drive up lane at establishment 10. Speaker 12 and microphone 14 are connected via cable 16 to base station 18 in the interior of establishment 10. An order taker 20, operating as an order taking facility, is able to communicate to a customer present in a vehicle in the drive up or drive-thru lane near the post 15 mounted speaker 12 and microphone 14. Typically, order taker 20 wears a belt-pack 22 coupled to an associated headset 24 by wire 26. Belt pack 22 commonly includes at least one button which order taker 20 may press to enable belt pack 22 to transmit to base station 18 and, via wire 16, to the customer located near the drive up post. Otherwise, belt pack 22 is commonly in “listen only” mode enabling order taker 20 to listen to the customer but not to talk to the customer.

Thus, the prior art system described above establishes a completely local, with respect to establishment 10, communication system and method enabling a customer located near a communication post near the drive-thru facility of establishment 10 to place an order for an item to be subsequently picked at establishment 10. In a typical embodiment for a fast food type restaurant, the customer drives up to post 15 at the drive-thru facility containing speaker 12 and microphone 14. The customer then typically peruses a menu board located in the vicinity of the drive-up post 15, selects the order and orally transmits the order directly to order taker 20 in establishment 10 through a communication link established by hardwire and, optionally, local intercom. The order is gathered and/or prepared and delivered to the customer at a pick-up window, usually after the customer has paid for the item, typically at the pick-up window.

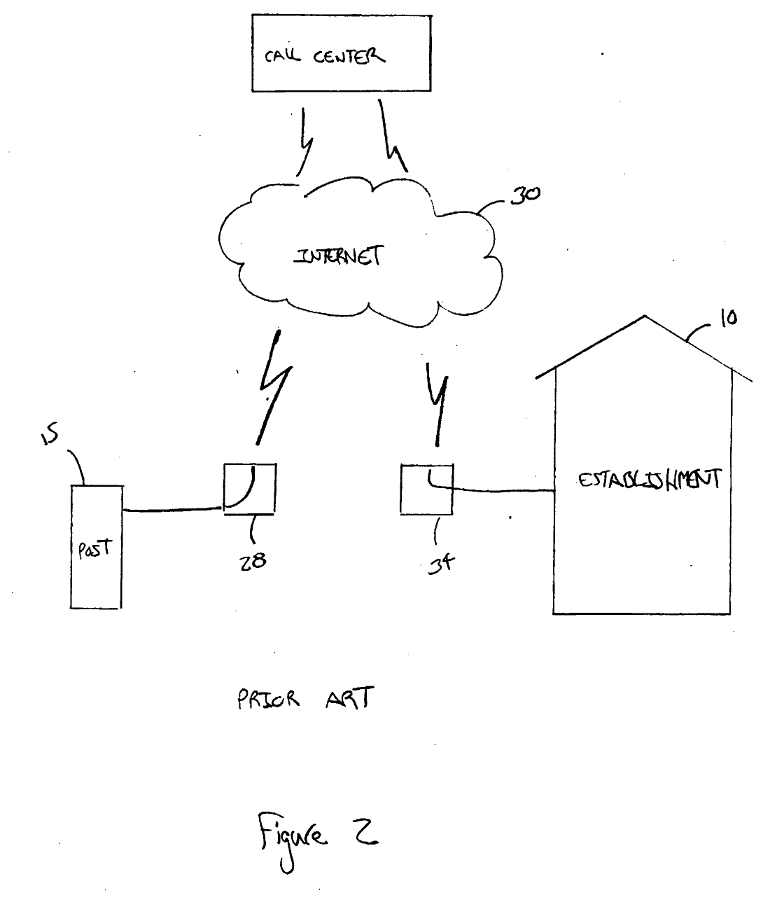

In contrast, the system described in U.S. Patent Application Publication No. US2003/0225622, Doan, entitled “Method and System For Entering Orders of Customers,” the contents of which is hereby incorporated by reference, uses an off-site order taking facility to handle the order taking function. An embodiment of this system is illustrated in block diagram of FIG. 2. As in the prior art system described above, a customer approaches drive-thru post 15, optionally peruses a menu board and selects an item or items to order. However, instead of speaking directly with someone in establishment 10, or otherwise located locally with respect to establishment 10, communication link 28 connects the customer, preferably via the internet 30 to a remote order taking facility such as call center 32. Call center 32 may be located in any place geographically but is generally preferred to be remote with respect to establishment 10, i.e., not located within or within the immediate vicinity of establishment 10. A representative in call center 32 may then communicate directly with the customer at drive-thru post 15 via communication link 28 to take the customer's order. Call center 32 then communicates the order to establishment 10 through a data link 34. Data link 34 transmits the order taken orally from the customer so that the order may be displayed, for example, to the employees of establishment 10 so that the order may be collected and/or prepared for delivery to the customer.

However, significant problems can ensue should either of communication link 28 or data link 34 fail completely or fail to maintain adequate reliability and speed to facilitate the generally uninterrupted order taking and order communication responsibility of call center 32.

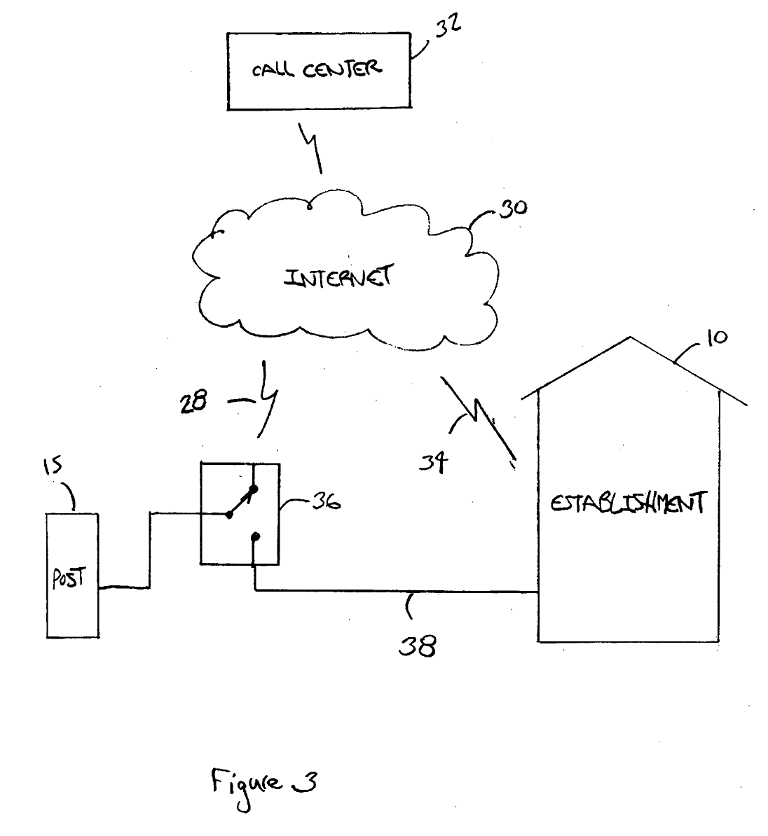

In an embodiment of the invention, a fall back communication link is provided to handle communication from the customer located near drive-thru post 15 to an order taking facility. An example of a system utilizing this embodiment is illustrated in FIG. 3. In normal operation, order taking responsibility is handled by call center 32 using communication link 28 from drive-thru post 15. The order taken is distributed to establishment 10 using data link 34. However whenever desirable or necessary, switching element 36 can intercept communication from drive-thru post 15 and instead route communication, typically oral, from drive-thru post 15 directly to an order taking facility, typically order taker 20, associated with establishment 10. Thus, order taking can revert from being handled by call center 32, via communication link 28 and internet 30, to being handled directly by establishment 10 via communication link 38.

Switching element 36 can switch order taking responsibility from establishment 10 to call center 32 and from call center 32 to establishment 10. Control of switching element 36 can be handled by establishment 10, call center 32 or automatically depending upon differing scenarios in different embodiments. Although it is preferred that call center 32 have primary responsibility for order taking, it is also possible that establishment 10 have primary responsibility for order taking with call center 32 only being in certain circumstances, during certain periods of activity such as busy time periods or slack time periods or during certain periods of the day such as meal times or between meal times.

In one embodiment, switching element 36 is under control of personnel in or associated with establishment 10. As an example, switching element 36 is controlled by a switch located within establishment 10 so that personnel in establishment 10 can designate which facility has order taking responsibility. This embodiment provides establishment 10 with great flexibility in choosing the responsible order taking facility.

In another embodiment, switching element 36 is operated automatically dependent upon certain predetermined conditions. As an example, switching element 36 switches responsibility for order taking from call center 32 to establishment 10, by utilizing communication link 38 instead of communication link 28, in response to one or both of communication link 28 or data link 34 becoming unavailable or upon one or more remote communication links becoming unstable or unreliable. In an embodiment, switching element 36 switches from call center 32 to establishment 10 after a remote communication link is unavailable for a predetermined period of time, for example, thirty (30) seconds.

In another embodiment, switching element 36 may be switched back, e.g., manually in establishment 10, or may be switched automatically, e.g., in response to remote communication links becoming available. In one embodiment, switching element 36 switches from establishment 10 to call center 32 only after remote communication become available and a predetermined period of time elapses between successive customers at drive-thru post 15. This will help ensure that sufficient time exists between customers so that a clear change of order taking responsibility occurs.

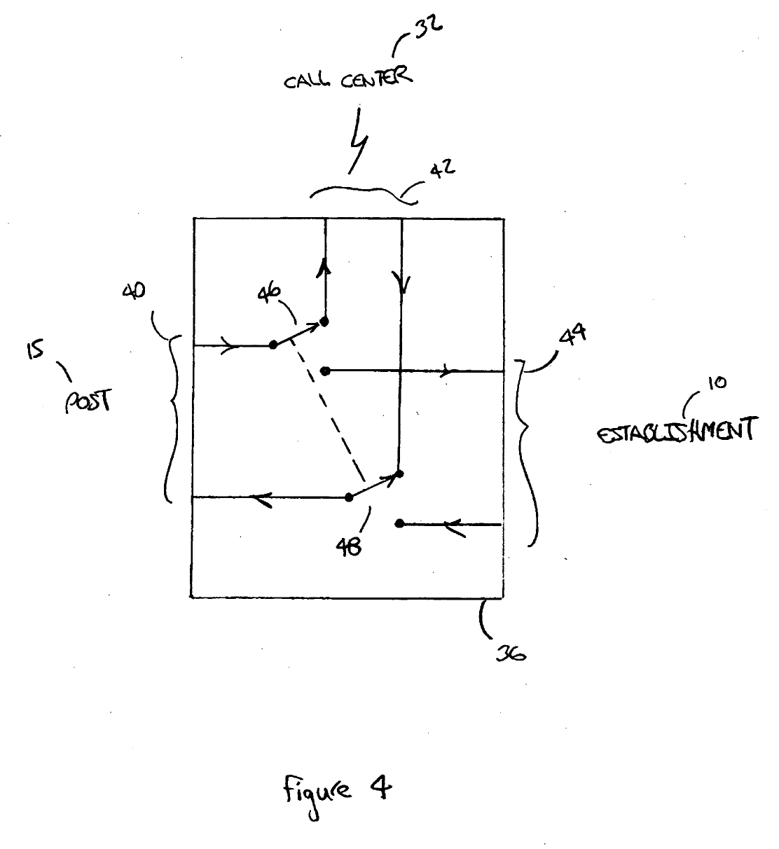

FIG. 4 illustrates a detailed schematic diagram of switching element 36. Switching element 36 may be located anywhere along communication links but preferably near drive-thru post 15 and/or establishment 10 so as to minimize the risk of an interruption in the communication link between drive-thru post 15 and establishment 10. In a preferred embodiment, switching element 36 is located in drive-thru post 15. Control of switching element 36 can still be located elsewhere, e.g., in establishment 10, in call center 32 or in an automatic switching arrangement.

Switching element 36 is operatively coupled to drive-thru post 15 through port 40. Switching element 36 is operatively coupled to call center 32 via communication link 28 and internet 30 through port 42. Switching element 36 is operatively coupled to establishment 10 via communication link 38 through port 44. Switching element 36 contains switches 46 and 48. Switch 46 handles “out going” communication, i.e., communication from drive-thru post 15 to either call center 32 or establishment 10. Switch 48 handles “incoming” communication, i.e., communication from call center 32 or establishment 10 to drive-thru post 15. Switches 46 and 48 are double-pole switches configured to operate in concert. When switches 46 and 48 are in an upper switched position, drive-thru post 15 is operatively coupled to call center 32. When switches 46 and 48 are in a lower switched position, drive-thru post 15 is operatively coupled to establishment 10.

In a preferred embodiment, an “outgoing” communication link, i.e., communication out from drive-thru post 15, is maintained between switching element 36 and establishment 10 even when call center 32 has order taking responsibility. In this scenario, personnel in establishment 10 can monitor oral communication occurring between drive-thru post 15 and call center 32 in order to gain an advance notice of orders being communicated to call center 32 or for other purposes. This additional communication link can be achieved by allowing switch 46 to also maintain contact with port 44 as well as port 42.

In another embodiment, another communication link, preferably oral, either is maintained or can be established between call center 32 and establishment 10. This additional communication link can be used by call center 32 personnel to follow up with an order transmitted to establishment 10 via data link 34. As an example, a customer may modify an already existing order after the order has been transmitted to establishment 10 perhaps to request a special service. This additional oral communication link can be used to keep personnel of establishment 10 knowledgeable about orders being placed without making them continuously responsible for facilitating order taking.

In an embodiment, microphone 14 is located in drive-thru post 15, microphone 14 being capable of receiving an oral order for the item from the customer. Speaker 12 is also located in drive-thru post 15, speaker 12 being capable of being heard by the customer.

In an embodiment, the present invention provides an order taking system for a plurality of establishments, each one of the plurality of establishments 10 each having a drive-thru post 15 enabling a customer at drive-thru post 15 to place an order for an item at that establishment 10. A remote order taking facility, call center 32 is located remotely from at least one of the establishments 10. Communication link 28 is associated with each of the plurality of establishments 10 between drive-thru post 15 and call center 32. Communication link 38 is associated with each of the plurality of establishments 10 between drive-thru post 15 and the local order taking facility, usually in each of the establishments 10. Switching element 36 is associated with each of the plurality of establishments 10 allows switching between communication link 28 and communication link 38.

In an embodiment, each of the plurality of establishments 10 may be individually switched between communication link 28 and communication link 38. Either communication link may be active at any point in time.

In an embodiment, a signal is provided to call center 32 in response to the customer being present at drive-thru post 15. This signal may take the form of an auditory signal, an icon or illustration on a computer display or any other sensory signal form to which call center 32 personnel may be responsive.

In an embodiment, a signal is provided to establishment 10 responsive to a customer being present at drive-thru post 15 even when call center 32 is responsible for order taking. Again, this signal may take any form but, in an embodiment, may be auditory. This signal may be useful to personnel in establishment 10 to alert them, particularly during slow periods, that an order is likely to be communicated shortly from call center 32. Establishment 10 personnel may be conducting cleaning or restocking functions, for example, during slow periods and the signal alerts them to be ready for an order when the order is transmitted.

While the various aspects of the invention have been described generally in the field of restaurants and, particularly fast food restaurants, it is to be recognized and understood that the present invention may find useful in many other establishments outside of the food or restaurant industry which may take advantage of remote order taking facility.

While the different communication links have been generally described as being hardwired when local and utilizing the internet when remote, it is to be recognized and understood that many other forms of communication links are contemplated to be utilized as well. Other types of communication links include telephone, both land line and wireless, walkie-talkie, leased lines, radio, satellite, microwave and the like. In a preferred embodiment, remote voice communications are established using voice-over-internet-protocol (VOIP).

Various modifications and alterations of this invention will be apparent to those skilled in the art without departing from the scope and spirit of this invention. It should be understood that this invention is not limited to the illustrative embodiments set forth above.

1: An order taking system for an establishment enabling a customer to place an order for an item from said establishment, the system comprising:
order placing equipment located near said establishment being capable of receiving an order for said item from said customer;
a local order taking facility associated with said establishment;
a first communication link adapted to communicate between said order placing equipment and a remote order taking facility;
a second communication link between said order placing equipment and said local order taking facility; and
a switching element that switches said order taking system from a first mode in which said order placing equipment is operatively coupled via said first communication link to said remote order taking facility to a second mode in which said order placing equipment is operatively coupled via said second communication link to said local order taking facility.

2. The order taking system of claim 1 wherein said switching element switches said order taking system from said first mode to said second mode under control of said establishment.

3: The order taking system of claim 1 wherein said order placing equipment comprises:
a microphone being capable of receiving an oral order for said item from said customer; and
a speaker being capable of being heard by said customer.

4: The order taking system of claim 1 wherein:
said first communication link facilitates oral communication of said order from said order placing equipment to said remote order taking facility and facilitates oral communication from said remote order taking facility to said order placing equipment; and
said second communication link facilitates oral communication of said order from said order placing equipment to said local order taking facility and facilitates oral communication from said local order taking facility to said order placing equipment.

5: The order taking system of claim 1 wherein said remote order taking facility comprises a call center.

6: The order taking system of claim 1 wherein said second communication link is hard-wired.

7: The order taking system of claim 1 wherein said establishment comprises a restaurant and wherein said order comprises a food order.

8: The order taking system of claim 1 wherein said second communication link couples said order placing equipment to said remote order taking facility via the internet.

9: The order taking system of claim 1 further comprising a third communication link that connects said remote order taking facility to said local order taking facility such that the order placed by the customer at said order placing equipment to said remote order taking facility is communicated back to said local order taking facility via said third communication link.

10: The order taking system of claim 1 wherein said switching element switches said order taking system from said first mode to said second mode automatically.

11: The order taking system of claim 10 wherein said switching element switches said order taking system from said first mode to said second mode automatically when said first communication link is unavailable.

12: The order taking system of claim 11 wherein said switching element switches said order taking system back to said second mode from said first mode when said first communication link becomes available once again following said first communication link becoming unavailable.

13: The order taking system of claim 10 wherein said switching element switches said order taking system from said first mode to said second mode automatically when said first communication link is unavailable for a pre-determined amount of time.

14: The order taking system of claim 13 wherein said pre-determined amount of time is approximately 30 seconds.

15: The order taking system of claim 10 wherein said switching element switches said order taking system from said first node to said second mode automatically when said first communication link is unavailable for a pre-determined amount of time and a pre-determined period of time elapses between successive customers at said order placing equipment.

16: The order taking system of claim 1 wherein said switch element includes a plurality of double-pole switches configured to operate in concert.

17: An order taking system for an establishment enabling a customer to place an order for an item from said establishment, the system comprising:
order placing equipment located near said establishment being capable of receiving an order for said item from said customer;
a local order taking facility associated with said establishment;
a remote order taking facility; and
a switching element that switches said order taking system from a first mode in which said order placing equipment is operatively coupled to said remote order taking facility to a second mode in which said order placing equipment is operatively coupled to said local order taking facility.

18: The order taking system of claim 17 wherein said switching element switches said order taking system from said first mode to said second mode under control of said establishment.

19: The order taking system of claim 17 wherein said switching element switches said order taking system from said first mode to said second mode automatically.

20: The order taking system of claim 19 wherein said switching element switches said order taking system from said first mode to said second mode automatically when a communication link between said order placing equipment and said remote order taking facility is unavailable for a pre-determined amount of time and a pre-determined period of time elapses between successive customers at said order placing equipment.
